(19) United States
(12) Patent Application Publication
(10) Pub. No.: US 2010/0273655 A1
(43) Pub. Date: Oct. 28, 2010

(54) Composition and method for controlling invasive aquatic flora

(76) Inventor: Vincent Mango, Jonesborough, TN (US)

Correspondence Address: Mark L. Davis, 633 Harmony Road, Jonesborough, TN, 37659, US

(21) Appl. No.: 12/803,665

(22) Filed: Jul. 1, 2010

Related U.S. Application Data
(63) Continuation-in-part of application No. 11/781,299, filed on Jul. 23, 2007.

(51) Int. Cl. A01N 43/90; A01P 13/00

(52) U.S. Cl. 504/235

(57) ABSTRACT

A herbicidal blend having from a) about 0.3 to about 4 parts by volume of a herbicide; b) from about 5 to about 20 parts by volume of a modified plant oil; and c) from about 5 to about 20 parts by volume of a compostable organic particulate. A method for preparing the herbicidal blend and a method of using the blend is also disclosed. The herbicidal blend is effective in controlling invasive water plant flora such as duckweed, watermeal and parrotfeather.

### CROSS REFERENCE TO RELATED APPLICATIONS

This application is a continuation-in-part of the application having U.S. Ser. No. 11/781,299 filed Jul. 23, 2007, the entire disclosure of which is incorporated herein by reference.

### FIELD OF THE INVENTION

The present invention relates to a composition and method of using the composition for controlling invasive aquatic plant flora. More particularly, the present invention relates to a herbicidal composition and a method of using the same for reducing and preferably eliminating invasive aquatic plant flora from a substantially non-dynamic water reservoir.

### BACKGROUND OF THE INVENTION

Generally, aquatic flora in and around waterways such as streams, rivers, ponds and lakes can serve many useful purposes, such as providing erosion control and providing a habitat for both land and marine wildlife. However, in some cases, one or more particular aquatic flora may not be conducive to the purpose of the waterway and may actually be detrimental to the aquatic wildlife, such as fish, salamanders, tadpoles and minnows, wreak havoc on the aquatic natural resources and be detrimental to the use of these resources. For example, in the case where the water is in a substantially non-dynamic reservoir, such as a pond or lake, invasive aquatic flora may be a substantial impediment to the purpose of the reservoir, and/or use of the water. As used herein, the term “substantially non-dynamic reservoir” means a body of water having an average dynamic flow rate of water of less than 100 liters per second through a pipe having a cross-sectional area of 1 square meter averaged over a period of 24 hours.

For example, one such invasive aquatic plant flora is Lemnna paucicostata, also known as duckweed. Conventionally, it has been very difficult to prevent or to control the growth of duckweed in a body of water such as a lake or pond. Another problematic, invasive aquatic plant flora is watermeal. Both duckweed and watermeal are free-floating plants than can totally cover the surface of a pond making the pond unfit for swimming and if left untreated, killing all the fish and other gilled animals in the pond. A surface layer of duckweed or watermeal will prevent sunlight from reaching the deeper parts of the water affecting natural underwater plants and algae that produce oxygen.

Duckweed plants are very small, about one-eight to one-quarter of an inch (3-6 millimeters) with a single root hanging from each plant. Watermeal is much smaller and in fact is the smallest flowering plant in existence. Watermeal plants look like tiny green seeds, each is less than one-sixteenth of an inch (less than 2 millimeters) in width.

Both plants are typically found in ponds having some overhanging foliage with woods at the water's edge or in ponds surrounded by woods, suggesting that leaf litter may play an important role in providing nutrients for growth. Spreading the infestation of these invasive water plants is believed to be associated with aquatic water foul, such as ducks and geese, since the plants can become lodged in their feathers, spreading seeds or plants from one water source to another. Given enough nutrients, duckweed and watermeal can proliferate to cover a pond, depending upon its size, in a matter of weeks. In some cases, a new plant will be produced every 24 hours giving an exponential growth accumulation of the plant.

Control of such invasive water flora is very difficult for both duckweed and watermeal. A few non-chemical methods include skimming or even draining the pond. The most effective control methods rely on chemicals approved for this purpose. One chemical is fluridone, sold commercially under various tradenames. It is important in the application of fluridone that the chemical be applied fairly evenly over the pond surface and plants. A problem with fluridone is that the effect is very slow, sometimes taking 2 or 3 months to show any noticeable results. Other problems with fluridone is that it takes a substantial amount of the chemical, over a quart per surface acre, to produce any effect and may not be effective or only slightly effective on watermeal. Another problem is the depth of the water. If the pond is greater than 5 feet a substantial greater amount of fluridone is required to achieve a noticeable result.

Another chemical approved for treatment of duckweed and watermeal aquatic plants is 6,7-dihydrodipyrido(1,2-a:2′,1′-c)pyrazinediium dibromide, commonly known as diquat dibromide. Generally, treatment requires at least one gallon per surface acre, (about 43,560 square feet). The diquat dibromide is diluted in 50 to 150 gallons of water and the plants are then saturated with the chemical. This is because diquat is a contact herbicide and will only affect plants the chemical comes in direct contact with. Over exposure hazards to humans and the environment are a concern from this type of application. The extensive amount of herbicidal material that must be used prolongs the contact time with the person applying the chemical and the application techniques are such that all the aquatic flora, perhaps even the plants surrounding the water are over applied with the chemical. Additionally, a nonionic surfactant must be added to the diquat for application.

Another problem with diquat dibromide that it sinks to the bottom of the pond after about 24 hours and is no longer available for contact with the plant flora, but is however available for ingestion of aquatic life, such as fish, tadpoles, and turtles. The material safety data sheet for diquat dibromide indicates that the material is toxic to beneficial algae (EC50 of 9.4 parts per billion) and desirable game fish such as rainbow trout (LC59 of 14.83 parts per million). Accordingly, it is desirable to use diquat dibromide in the lowest possible concentrations and achieve the greatest efficacy in controlling such nuisance aquatic plant flora.

Yet another problematic water plant is Myriophyllum aquaticum and Myriophyllum spicatum also referred to as Eurasian watermilfoil are sometimes both commonly referred to as parrotfeather. Parrotfeather infestations can alter aquatic ecosystems as its dense mats shade out other native aquatic plants, inhibits water flow and recreational activities, such as boating and swimming. Parrotfeather is typically a submerged aquatic plant that has both an emergent stems that can grow about a foot out of the water and submerged leaves. The leaves resemble small fir trees. The plant typically has long intertwined rhizomes that form a dense mat. Another problem with parrotfeather is that the dense mat makes it ideal habitat for mosquito larvae. Treating parrotfeather with a topical herbicide can be difficult because the emergent leaves and stems are covered in a waxy cuticle that inhibits herbicide uptake.

Accordingly, there is a need for an effective chemical control of these and other invasive aquatic flora that would have a lower environmental impact on aquatic wildlife.

### SUMMARY OF THE INVENTION

Briefly, the present invention is a herbicidal composition for controlling invasive aquatic plant flora in a substantially non-dynamic water reservoir such as a pond, lake or stream. The herbicidal composition is a blend having from about 0.3 to about 4 parts by volume of a herbicide formulation having an effective amount of at least one herbicide; from about 5 to about 20 parts by volume of a modified plant oil; and from about 5 to about 20 parts by volume of a compostable organic particulate.

Another aspect of the present invention is for a method of making a herbicidal mixture, the method including the steps of adding to a container (i) from about 0.3 to about 4 parts by volume of a herbicidal formulation, the formulation containing an effective amount of at least one herbicide (ii) from about 5 to about 20 parts by volume of a modified plant oil; and (iii) from about 5 to about 20 parts by volume of a compostable organic particulate wherein the organic particulate is from about 45 to about 55% by volume of the constituents (i)-(iii); and b) agitating the container to mix or blend the all the constituents into a substantially uniform suspension.

Another aspect of the present invention is a method for treating a substantially non-dynamic water reservoir having at least one invasive aquatic plant flora, the method including the steps of a) preparing the herbicide mixture described above, and b) contacting at least a portion of the invasive aquatic plant flora with the herbicide mixture.

It is an object of the present invention to provide a more efficacious herbicidal composition for controlling invasive aquatic plant flora.

Another object of the present invention is to provide a method of using the herbicidal composition for controlling one or more invasive and undesirable aquatic plant flora.

### BRIEF DESCRIPTION OF THE FIGURES

The patent or application file contains at least one photograph executed in color. Copies of this patent or patent application publication with color photographs will be provided by the Office upon request and payment of the necessary fee.

FIG. 1 is a color photograph of a mixture having an aquatic herbicide formulation admixed with and a non-modified plant oil.

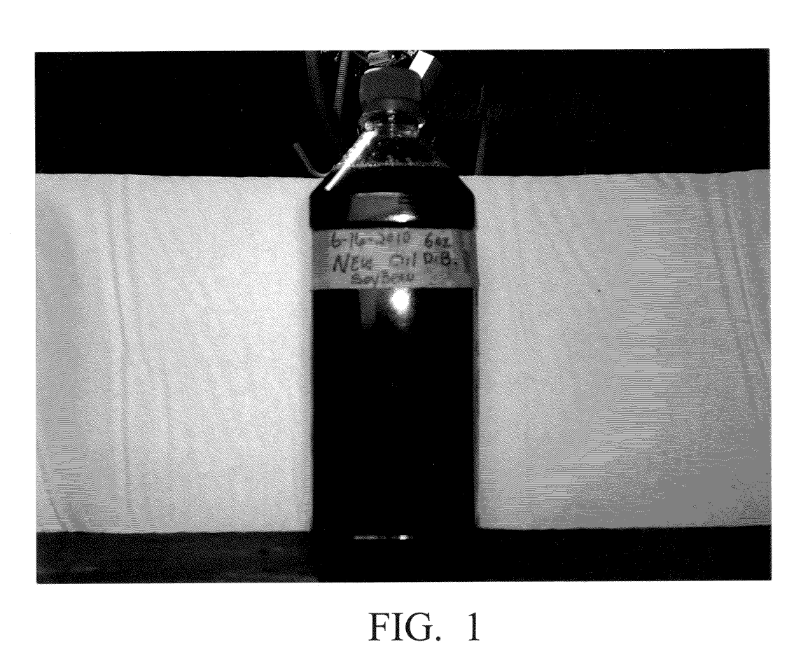

FIG. 2 is a color photograph of two containers, one container showing the herbicidal formulation in accordance with the present invention admixed; and the second container showing a separation of the organic particulate after sitting for five days

FIG. 3 is a color photograph of about 200 milliliters (ml) of the blended herbicidal formulation in accordance with the present invention poured on top of about 600 ml of water.

FIG. 4 is a color photograph of the mixture presented in FIG. 1 and the blended herbicidal formulation in accordance with the present invention presented in FIG. 3 taken two days after the initial picture, each without further disturbance.

FIG. 5 is a color photograph of an apparatus for applying the herbicidal formulation of the present invention to a body of water.

FIG. 6 is a color photograph of a body of water having a duckweed infestation and showing an application of the herbicidal formulation of the present invention to the duckweed.

FIG. 7 is a color photograph of the body of water of FIG. 6 after about 30 days.

FIG. 8 is a color photograph of the body of water of FIG. 6 after about 32 days

FIG. 9 is a color photograph of a second body of water having a parrotfeather infestation prior to application of about 32 ounces of the herbicidal formulation of the present invention.

FIG. 10 is a color photograph of the second body of water of FIG. 9 after about 4 days.

FIG. 11 is a color photograph of a third body of water having a watermeal infestation prior to the application of the herbicidal formulation of the present invention.

FIG. 12 is a color photograph of the third body of water of FIG. 11 four (4) days after a single application of the herbicidal formulation of the present invention illustrating a substantial elimination of watermeal from the surface of the pond, with less than about 10% of the surface still containing the plant.

FIG. 13 is a color photograph of the third body of water of FIG. 11 thirteen (13) days after a single application the herbicidal formulation of the present invention illustrating elimination of watermeal from the surface of the pond.

FIG. 14 is a color photograph of the first body of water after application of the herbicidal formulation of the present invention demonstrating that there is no damage to the ability of aquatic life to live and thrive in a treated body of water.

### DETAILED DESCRIPTION OF THE INVENTION

In accordance with one aspect of the present invention, a herbicidal composition is provided that is useful for controlling invasive aquatic plant flora. The herbicidal composition is a blend having a) from about 0.3 to about 4 parts of a herbicide formulation containing an effective amount of at least one herbicidal agent; b) from about 5 to about 20 parts by volume of a modified plant oil; and c) from about 5 to about 20 parts by volume of a compostable organic particulate. Desirably, the compostable organic particulate is from about 45 to 65 volume % of the constituents (a)-(c) in the herbicidal blend. Advantageously, the herbicidal composition of the present invention can be utilized as a herbicidal preemergence or postemergence for controlling populations of invasive aquatic plant flora. The delivery mode for the herbicidal composition may be applied by ground, using boats or by aerial techniques to a variety of aquatic habitats.

Herbicides and herbicidal formulations useful in the present invention include, but are not limited to, acetochlor, acifluorfen, acrolein, alachlor, alloxydim, ametrydione, amidosulfuron, amitrole, ammonium aulfamate, asulam, atrazin, azimsulfuron, benfuresate, bensulfuron, bentazon, bifenox, bromobutide, bromoxynil, butachlor, bromacil, cafenstrole, carfentrazone, chloridazon, chlorimuron, chlorpropham, chlorsulfuron, chlortoluron, cinmethylin, cinosulfuron, clomazone, clopyralid, copper/copper sulfate, cyanazin, cycloate, cyclosulfamuron, cycloxydimdalapon, daimuron, desmedipham, dicamba, dichlobenil, diflufenican, dimethenamid, di-methazone, diquat dibromide, dithiopyr, diuron, endothall, eptame, esprocarb, ethiozin, fenac, fenoxaprop, fluridone, flurtamone, fluthiamid, fomesafen, glufosinate, glyphosate, halosafen, haloxyfop, hexazinone, imazamethabenz, imazamethapyr, imazamox, imazapyr, imazaquin, imazethapyr, ioxynil, isoproturon, isoxaben, isoxaflutole, lactofen, mefenacet, metabenzthiazuron, metamitron, metazachlor, methyldimron, metolachlor, metribuzin, metsulfuron, molinate, nicosulfuron, norflurazon, oryzalin, oxadiargyl, oxasulfuron, oxyfluorfen, petroleum solvents, pendimethalin, picloram, pretilachlor, propachlor, propanil, prosulfocarb, pyrazosulfuron, pyridate, prometon, qinmerac, quinchlorac, quizalofopethyl, sethoxydim, silvex, simetryne, simazine, sulcotrione, sulfentrazone, sulfosate, tebuthiuron, terbutryne, terbutylazin, thiameturon, thifensulfuron, thiobencarb, tralkoxydim, triallate, triasulfuron, tribenuron, triclopyr, trifluralintrichloroacetic acid, 2,4-D, xylene, Aquazine®, Aquathol K®, Aquashade®., Aqualin®, Banvel®, Casoron®, Cutrine®-Plus, Cytrol®. Amitrole®-T, Dichlone®, Dowpon®, Endothal®, Fenac®, Hydrothal®-191, Hydrothal®-47, Hydrout®, K-Tea®, Komeen®, Karmex®, Monuron®, Revenge®, Reward®, Rodeo®, Roundup®, Scout®, Sonar®, Spike®, System®, System L®, Banvel®-720, Aqualine®, Ammate®, Hyvar®, Cardi®, Tordon®, 22K, Primatol®, Pramitol®, Juron®, Aqua Kleen®, Weedone®, Velpar®, Diquat®, and mixtures thereof. Such compounds can also be used in the form of their respective salts, esters, and amides depending upon the particular parent compound. Herbicides and herbicidal formulations containing an effective amount of diquat dibromide are preferred. The herbicidal formulation of the present invention may further be combined with other aquatic herbicides in an amount that would be effective. The use of other aquatic herbicides in the present formulation often provides compositions which are more effective than separate compositions of the individual compounds.

As used herein a herbicide is any material, chemical, agent, or mixtures thereof used for killing or controlling immature or mature stages of invasive aquatic plant flora, or for severely interrupting their normal growth processes of such plant flora. Herbicidal materials and formulations may effect pre-emergence or post-emergence vegetation and can include herbicides, desiccants, algicides, defoliants, hormones, plant growth regulators, plant growth inhibitors, sterilants, biological control agents, microbial control agents, and/or pathogens.

Desirably, plant oils which may be modified and are useful in the present invention is any plant derived oil that is a liquid at a temperature of about 40° F. Suitable oils for modification include, but are not limited to, palm oil, soybean oil, sunflower oil, olive oil, corn oil, nut oils, such as for example, peanut oil and almond oil, safflower oil, coconut oil, rapeseed oil, canola oil, banana oil, orange oil, cotton seed oil and mixtures thereof. Desirably, oils suitable for the present invention have a density of less than 1 gram/milliliter (g/mL) at 25° C. and more preferably have a density of from about 0.86 to about 0.98 g/mL at 25° C. Preferred plant oils for use in the present invention include corn oil, soybean oil, sunflower oil, safflower oil, canola oil, peanut oil and mixtures thereof since these vegetable oils are typically used in commercial restaurants and are the available for collection after use or modification. As used herein the term “modified plant oil” does not include any plant oil that has been blended with one or more organic or inorganic materials that substantially alter the quality or characteristic of the oil. Examples of such materials include benzene, toluene, mineral spirits, paint thinner, methylene chloride, diesel fuel, gasoline, C₅-C₂₂ alkylanes, C₅-C₂₂ cycloalkylanes, C₆-C₂₂ alkylenes, C₈-C₂₄ aryls, and mixtures thereof. One skilled in the art will understand that the present invention may contain one or more of these substances as additives such as surfactants, retardants, and antioxidants, but the quantity present does not substantially alter the characteristic of the oil being utilized in the herbicidal composition of the present invention. As used herein, the term “substantially alter” means a deviation in at least one physical property of the oil, selected from viscosity, specific gravity, and water solubility, compared to an oil sample without the additive, of greater than about 50%, preferably greater than about 35%, and more preferably greater than about 25% based on the oil at 25° C. without any organic or inorganic material added.

Desirably, the modified plant oil of the present invention is a used vegetable oil that has been utilized for cooking battered and non-battered food items, such as fresh or frozen potatoes and potato based products, onions and onion based products, okra, corn, carrots, fresh and frozen fish, oysters, shrimp and the like at a temperature greater than about 300° F., and preferably from about 350°-450° F. from 10 to about 2800 minutes.

An important aspect of the present invention is the inclusion of a compostable organic particulate. As used herein, the term “compostable” means a primarily plant based composition that will decay and can be utilized as a fertilizer or plant nutrient. Compostable organic particulates suitable for the present invention include all manner of primarily plant residues such as, for example, ground leaves, ground corn, ground corn husks, ground wheat and wheat chaff, ground coconut husks, ground rice and rice husks, ground barley, ground whole oats, finely ground wood dust, used coffee grounds, ground pecan shells, and coco bean hulls. As used herein, the term “finely ground” means that the material will pass through a 17 mesh screen, and preferably meets the size description contained herein. In one embodiment, the compostable organic particulate is a residual sediment derived from a vegetable coating batter that has been subjected to an oil bath at a temperature of from about 200° to 400° F. from 1 to 2800 minutes. Typically, this material is a solid or semi-solid residue present in the bottom of deep fryer vats used in restaurants. Desirably, the compostable organic particulate has an average size of less than 17 mesh, and preferably, has an average size of from about 0.1×10⁻¹²of an inch to less about 17 mesh. More preferably, the compostable organic particulate has an average size of about 0.1×10⁻¹² of an inch to less than about 30 mesh. Preferably, the organic particulate has a specific gravity of less than 1 gram/cubic centimeter. In one embodiment, the organic particulate has a specific gravity greater than the specific gravity of the modified oil used in making the herbicidal formulation of the present invention, but less than water.

In another embodiment, the herbicidal composition of the present invention includes from about 0.5 to about 2 parts and from about 5 to about 10 parts each of the modified plant oil and the compostable organic particulate, wherein the compostable organic particulate is from about 40 to about 65% by volume of the total blend.

In another embodiment, the herbicidal composition of the present invention includes from about 0.5 to about 1 parts by volume of the herbicidal formulation and from about 5 to about 8 parts each of the modified plant oil and the compostable organic particulate, wherein the compostable organic particulate is from about 45 to about 55% by volume of the total blend.

The formulations of the present invention can be applied to the site of the aquatic plant life infestation by contacting the surface of the plant life and/or contacting the water with the herbicide in any manner recognized in the art. Preferably, application is achieved by using a shaker bottle having an appropriate opening orifice to allow free flow of the herbicidal blend of the present invention to contact the aquatic plant life and/or the water. Surprisingly, the finished non-aqueous formulations of the present invention are stable in storage, even on storage over a period of several years.

The concentration of the active compound in the herbicidal formulation of the present invention will vary greatly with the type of formulation, the purpose for which it is designed, the particular plant specie and flow rate of the water. Generally, a rate of application is from about 2 ounces to about 128 ounces of the herbicidal formulation of the present invention per surface acre of water.

The present invention is illustrated in greater detail by the specific examples presented below. It is to be understood that these examples are illustrative embodiments and are not intended to be limiting of the invention, but rather are to be construed broadly within the scope and content of the appended claims. All parts and percentages in the examples are on a volume basis unless otherwise stated.

### Example 1

### Preparing Modified Plant Oil

Approximately five gallons of fresh soybean oil was placed in a commercial deep fryer and heated to a temperature of about 400° F. The oil was used for a period of about 10 hours to cook various breaded vegetables. At the end of the day, the oil from the deep fryer along with the sediment was allowed to cool then drained into an appropriate storage container. Upon cooling, the modified plant oil (used plant oil) and compostable particulate matter (sediment from the deep fryer) were agitated to suspend the compostable particulate matter. The total contents were then filtered through a 17 mesh screen into a clean container. Any compostable particulate matter greater than 17 mesh was discarded. The modified plant oil and compostable particulate matter in the container were allowed to rest for about five (5) days to clarify the modified plant oil by letting the compostable particulate matter separate from the modified soybean oil.

### Example 2

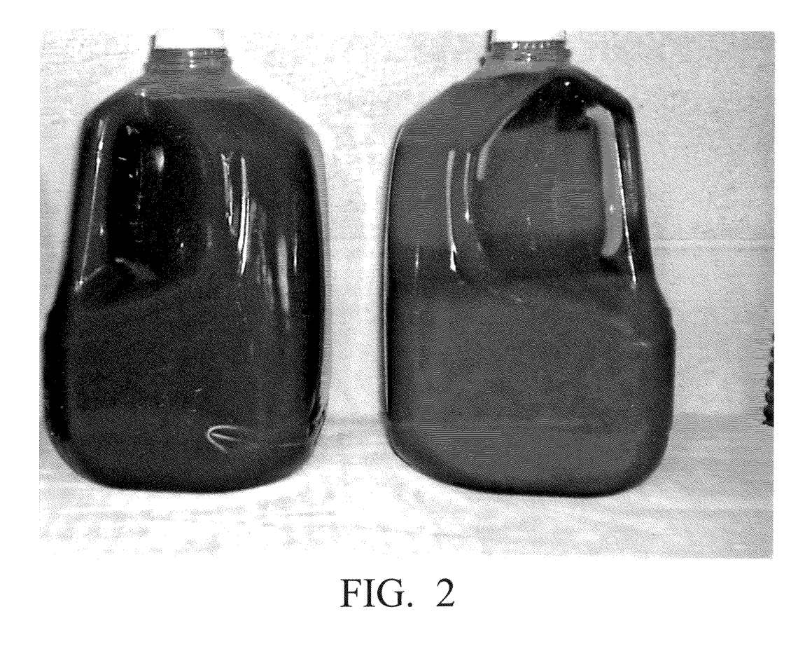

To prepare the herbicidal composition of the present invention, decant from the container containing compostable particulate matter and modified plant oil of Example 1, an amount of the modified soybean oil so that the amount of modified oil (volumetrically) remaining in the container is about equal to the amount of compostable particulate matter. The container with about equal parts of modified oil and compostable particulate matter was agitated to suspend the compostable particulate matter. Approximately one gallon of this suspension was transferred to a gallon jug. About eight (8) ounces of a commercially available aquatic herbicide formulation having a concentration of diquat dibromide of 37.3 vol. % was added to the gallon jug. After adding the diquat formulation, the contents were agitated sufficiently for thoroughly mix or blend the constituents together, see FIG. 2.

### Example 3

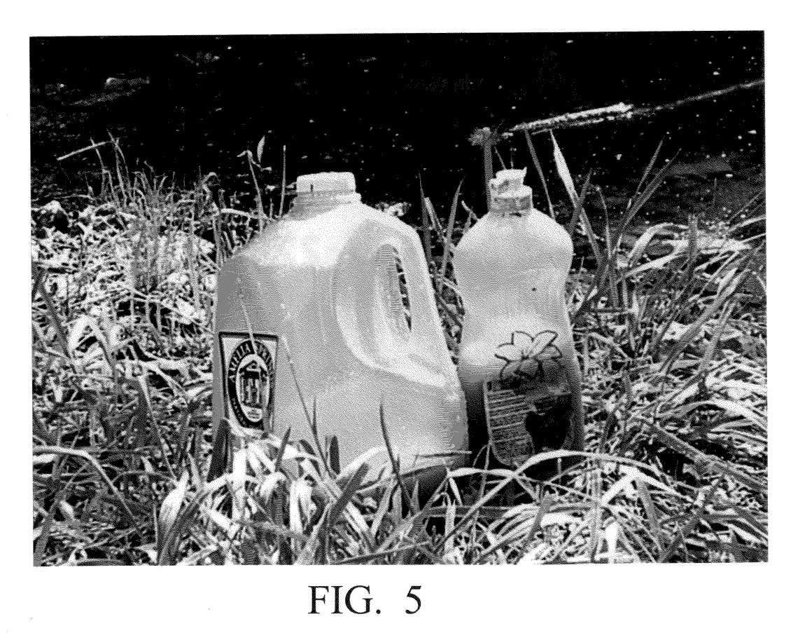

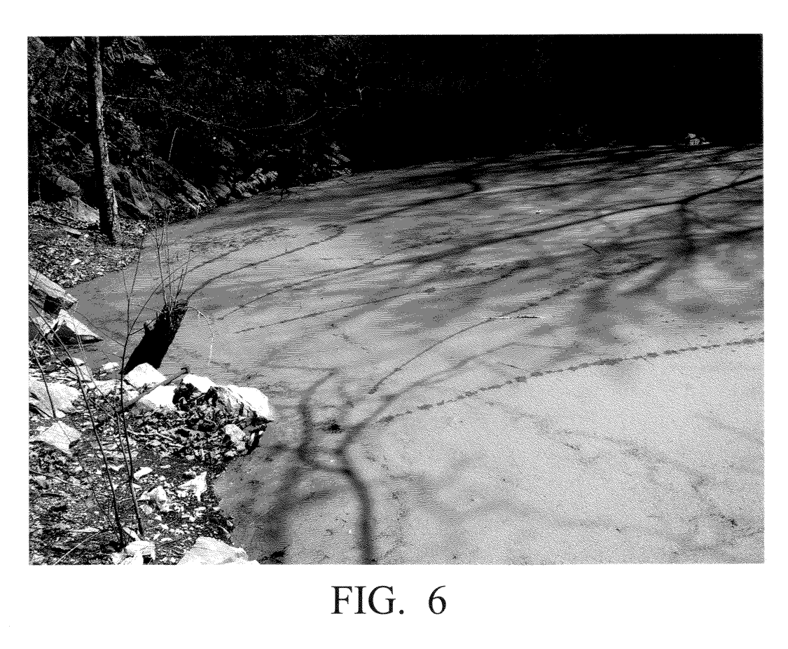

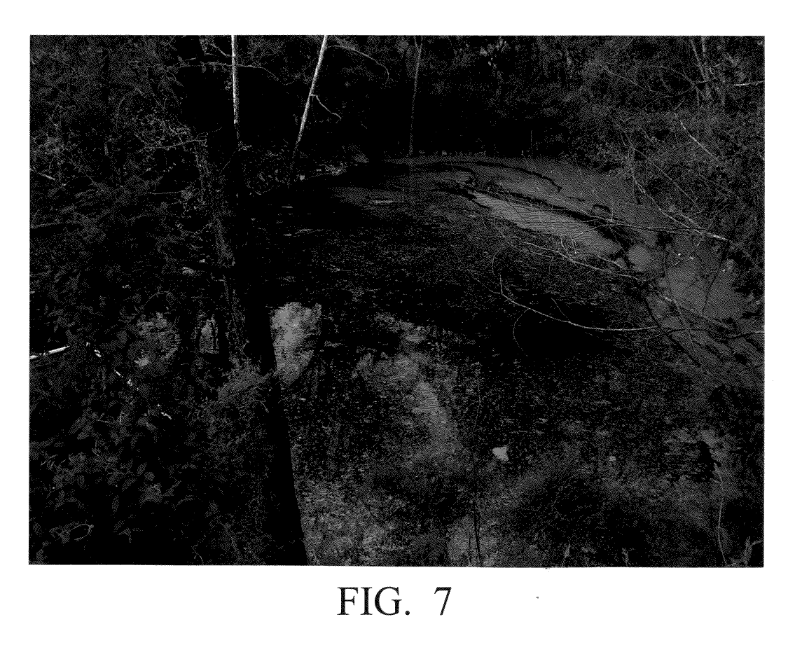

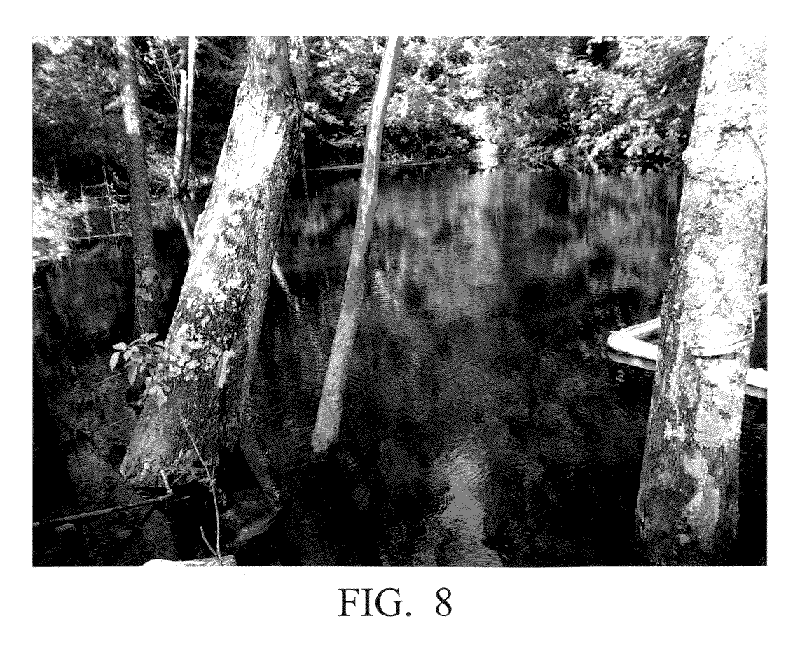

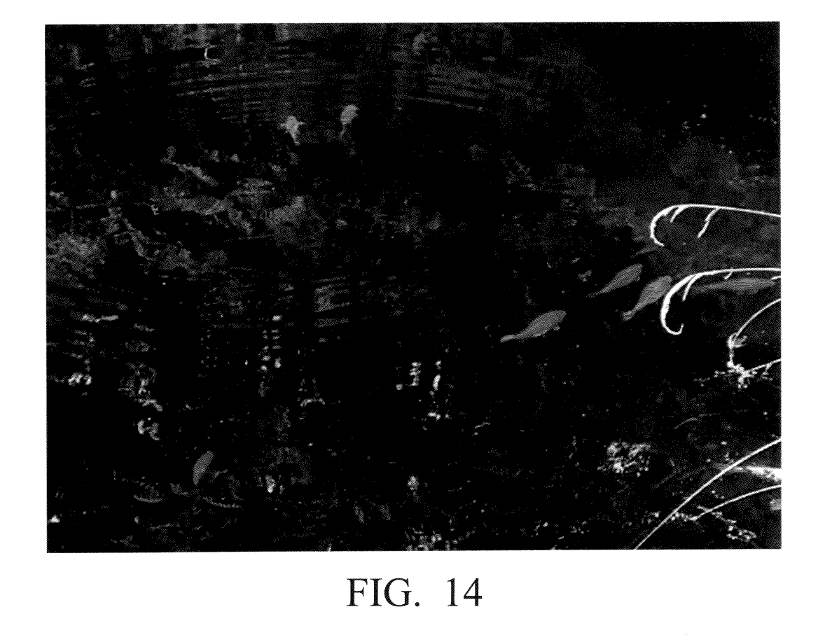

Referring to FIGS. 5-8, about 25 ounces of the blend of Example 2 was added to a clean dishwashing detergent squeeze bottle. Approximately 128 ounces of the herbicidal composition of the present invention was then used to treat a pond covered by duckweed, see FIG. 6. The pond had a surface area of about 11,000 square feet. The blended herbicidal composition was squirted out onto only a portion of the pond surface covered by the duckweed. After about 30 days, the mat of duckweed had receded, see FIG. 7. After 32 days with a single treatment, complete control of the duckweed infestation was achieved, see FIG. 8. Advantageously, application of the herbicidal formulation of the present invention does not harm the aquatic life in the pond, see FIG. 14.

### Example 4

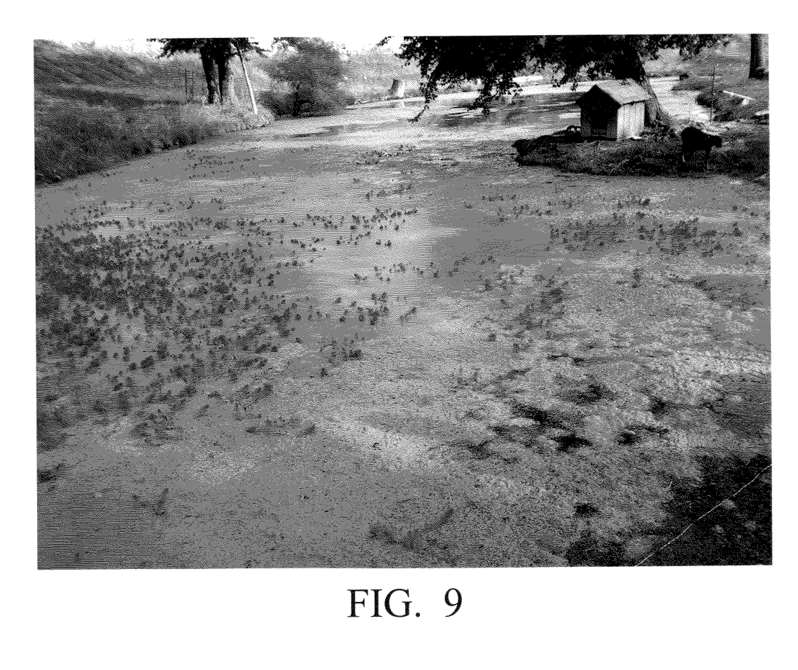

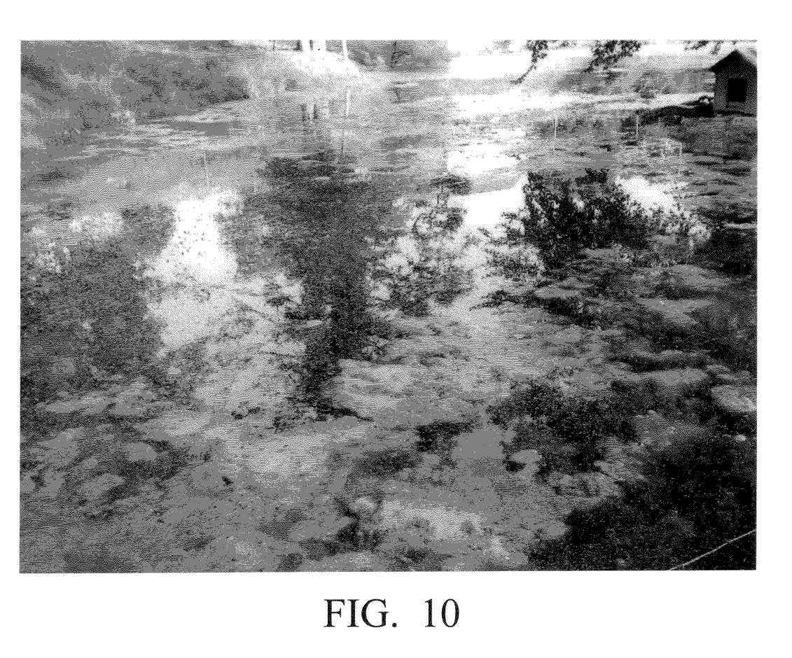

Referring to FIGS. 9-10 about 25 ounces of the blend of Example 2 was added to a clean dishwashing detergent squeeze bottle. Approximately 32 ounces of this material was then used to treat a pond infested with parrotfeather, see FIG. 9. The pond had a surface area of about 2880 square feet. The blended herbicidal composition was squirted out onto only a portion of the pond surface covered by the parrotfeather. After 2 days, the mat of parrotfeather began to recede. After 4 days with a single treatment, the parrotfeather infestation had significantly receded, see FIG. 10.

### Example 5

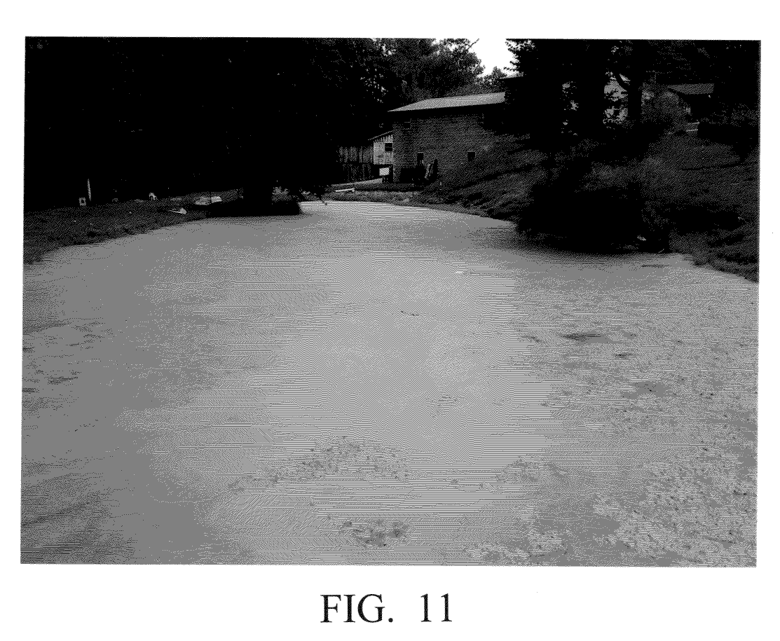

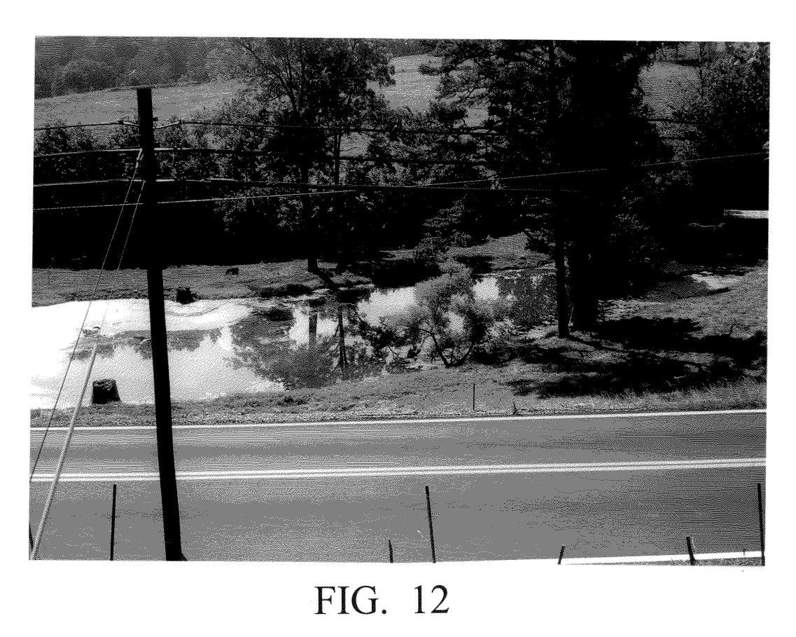

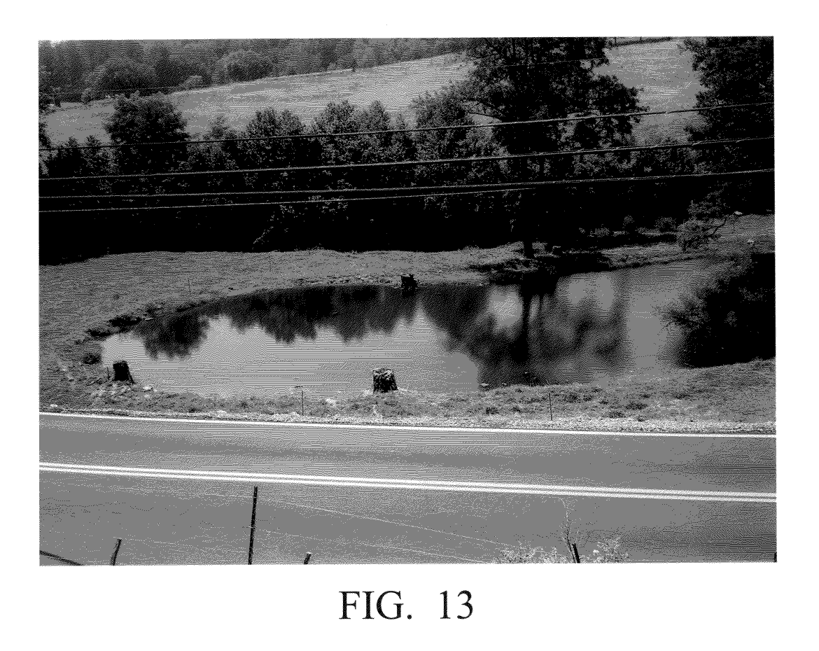

Referring to FIGS. 11-13 about 25 ounces of the blend of Example 2 was added to a clean dishwashing detergent squeeze bottle. Approximately 128 ounces of the herbicidal composition of the present invention was then used to treat a pond covered by watermeal, see FIG. 11. The pond had a surface area of about 20,000 square feet. The blended herbicidal composition was squirted out onto only a portion of the pond surface covered by the watermeal. After 4 days with a single treatment, a substantial thinning of the plant infestation was achieved, see FIG. 12. It was estimated that less than about 10% of the pond's surface contained watermeal. After 13 days elimination of the watermeal infestation was achieved, see FIG. 13.

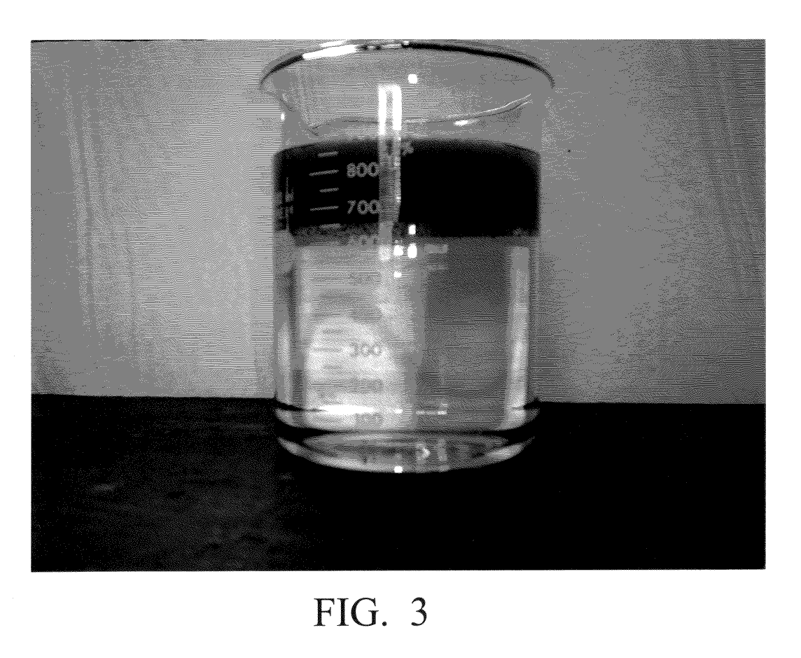

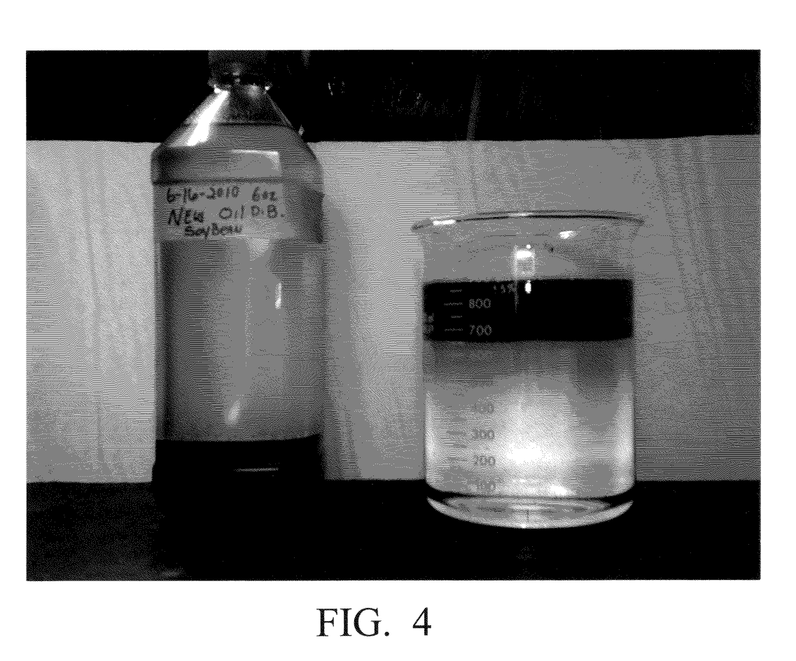

It was surprising and quite unexpected that a water soluble herbicide formulation, such as diquat dibromide which has a large water solubility (718,000 mg/liter), could be utilized with an oil mixture without complete separation of the herbicide from the oil, as can be seen in FIG. 4. Not wanting to be bound by any theory, it is suspected that the compostable particulate matter, which in this embodiment consists of deep fried vegetable matter, may absorb the active herbicide or retain a portion of the active herbicide on the surface of the particle. Moreover, it was surprising that this compostable particulate matter did not separate from the blend when added to water, as is seen in FIGS. 3 and 4 and remained in suspension for over 2 days. Surprisingly, the herbicidal formulation of the present invention provided a route for plant up-take of the active herbicide for well over 24 hours.

In view of the literature directed to using a herbicide containing diquat dibromide, it was further surprising and quite unexpected that substantially lesser amounts could be used to control these invasive aquatic plant flora. It is clear from the literature that this is contact herbicide. Accordingly, prior to the present invention, application of diquat dibromide required heavily coating or spraying each plant to effect control. It was surprising that the invasive aquatic flora over the entire surface was controlled with only a portion of the plant flora initially coming into contact with the herbicidal formulation of the present invention. Not wishing to be bound by any theory, it is surprising that the herbicidal composition of the present invention produces a more systemic herbicidal effect. It was further surprising that the herbicidal formulation of the present invention allows for a more efficacious manner for plant control, uses a substantial lesser amount of herbicide per given treatment and provides a longer contact time for the active herbicidal agent. This is very beneficial to native aquatic wildlife by allowing lower concentrations of the active agent to be used in a more efficacious manner.

Another surprising beneficial effect of the present invention is that the active herbicide agent remains effective on the aquatic plant flora for more than 24 hours. For example, literature on diquat dibromide stated that the herbicide settles to the bottom of the pond, lake or reservoir within 24 hours. Applicant unexpectedly discovered that the present herbicidal composition allowed for a greater residence time with the aquatic plant flora, as seen in FIG. 3, enhancing efficacy while using lower concentrations of the active herbicidal ingredient.

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

What is claimed is:

1. A herbicidal composition comprising a blend of
a) from about 0.3 to about 4 parts by volume of a herbicide formulation, said formulation containing an effective amount of at least one herbicidal agent;
b) from about 5 to about 20 parts by volume of a modified plant oil; and
c) from about 5 to about 20 parts by volume of a compostable organic particulate.

2. The herbicidal blend of claim 1 wherein said herbicidal agent is selected from the group consisting of acetochlor, acifluorfen, acrolein, alachlor, alloxydim, ametrydione, amidosulfuron, amitrole, ammonium aulfamate, asulam, atrazin, azimsulfuron, benfuresate, bensulfuron, bentazon, bifenox, bromobutide, bromoxynil, butachlor, bromacil, cafenstrole, carfentrazone, chloridazon, chlorimuron, chlorpropham, chlorsulfuron, chlortoluron, cinmethylin, cinosulfuron, clomazone, clopyralid, copper/copper sulfate, cyanazin, cycloate, cyclosulfamuron, cycloxydimdalapon, daimuron, desmedipham, dicamba, dichlobenil, diflufenican, dimethenamid, di-methazone, diquat dibromide, dithiopyr, diuron, endothall, eptame, esprocarb, ethiozin, fenac, fenoxaprop, fluridone, flurtamone, fluthiamid, fomesafen, glufosinate, glyphosate, halosafen, haloxyfop, hexazinone, imazamethabenz, imazamethapyr, imazamox, imazapyr, imazaquin, imazethapyr, ioxynil, isoproturon, isoxaben, isoxaflutole, lactofen, mefenacet, metabenzthiazuron, metamitron, metazachlor, methyldimron, metolachlor, metribuzin, metsulfuron, molinate, nicosulfuron, norflurazon, oryzalin, oxadiargyl, oxasulfuron, oxyfluorfen, petroleum solvents, pendimethalin, picloram, pretilachlor, propachlor, propanil, prosulfocarb, pyrazosulfuron, pyridate, prometon, qinmerac, quinchlorac, quizalofopethyl, sethoxydim, silvex, simetryne, simazine, sulcotrione, sulfentrazone, sulfosate, tebuthiuron, terbutryne, terbutylazin, thiameturon, thifensulfuron, thiobencarb, tralkoxydim, triallate, triasulfuron, tribenuron, triclopyr, trifluralintrichloroacetic acid, 2,4-D, xylene, Aquazine®, Aquathol K®, Aquashade®., Aqualin®, Banvel®, Casoron®, Cutrine®-Plus, Cytrol®. Amitrole®-T, Dichlone®, Dowpon®, Endothal®, Fenac®, Hydrothalal®-191, Hydrothal®-47, Hydrout®, K-Tea®, Komeen®, Karmex®, Monuron®, Revenge®, Reward®, Rodeo®, Roundup®, Scout®, Sonar®, Spike®, System®, System L®, Banvel®-720, Aqualine®, Ammate®, Hyvar®, Cardi®, Tordon®, 22K, Primatol®, Pramitole, Juron®, Aqua Kleen®, Weedone®, Velpar®, Diquat®, and mixtures thereof.

3. The herbicidal blend of claim 2 wherein said herbicidal agent is diquat dibromide.

4. The herbicidal blend of claim 3 wherein said blend comprises from about 0.5 to about 2 parts by volume of said herbicidal formulation.

5. The herbicidal blend of claim 3 wherein said blend comprises from about 0.5 to about 1 part by volume of said herbicidal formulation.

6. The herbicidal blend of claim 1 wherein said modified plant oil is selected from the group consisting of palm oil, soybean oil, sunflower oil, olive oil, corn oil, peanut oil, safflower oil, coconut oil, rapeseed oil, canola oil, cotton seed oil and mixtures thereof.

7. The herbicidal blend of claim 6 wherein said modified plant oil is a used vegetable cooking oil.

8. The herbicidal blend of claim 7 wherein said used cooking oil has been filtered to remove particulate matter having a size greater than 17 mesh.

9. The herbicidal blend of claim 1 wherein said organic particulate has an average size of from 0.1×10⁻¹² of an inch to less about 17 mesh.

10. The herbicidal blend of claim 9 wherein said compostable organic particulate is selected from the group consisting of ground leaves, ground corn, ground corn husks, ground wheat and wheat chaff, ground coconut husks, ground rice and rice husks, ground barley, ground oats, finely ground wood dust, used coffee grounds, ground pecan shells, and coco bean hulls and a residual sediment derived from a vegetable coating batter from used vegetable cooking oil.

11. The herbicidal blend of claim 1 wherein said blend has from about 5 to about 10 parts each of said modified plant oil and said compostable organic particulate, wherein said compostable organic particulate is from about 40 to about 65% by volume of the total blend.

12. The herbicidal blend of claim 1 wherein said blend has from about 5 to about 8 parts each of said modified vegetable oil and said compostable organic particulate, wherein said compostable organic particulate is from about 45 to about 55% by volume of the total blend.

13. The herbicidal blend of claim 12 wherein said compostable organic particulate is a residue particulate from used cooking oil selected from the group consisting of soybean oil, sunflower oil, olive oil, corn oil, peanut oil, safflower oil, coconut oil, rapeseed oil, cotton seed oil and mixtures thereof, and wherein said organic residue particulate passes through a 17 mesh screen.

14. The herbicidal blend of claim 9 wherein said organic particulate has a size of from about 0.1×10⁻¹² to about 30 mesh.

15. A method for preparing a herbicidal mixture comprising:
a) adding to a container (i) from about 0.3 to about 4 parts by volume of a herbicidal formulation, said formulation containing an effective amount of at least one herbicidal agent of claim 2 (ii) from about 5 to about 15 parts by volume of a modified plant oil;
and (iii) from about 5 to about 15 parts by volume of an organic particulate wherein said organic particulate is from about 45 to about 65% by volume of the constituents (i)-(iii); and
b) agitating the container to mix or blend the all the constituents into a substantially uniform suspension.

16. The method of claim 15 wherein (i) is from about 0.5 to 1 part.

17. The method of claim 15 wherein said organic particulate is an organic residue particulate from a used cooking oil selected from the group consisting of soybean oil, sunflower oil, olive oil, corn oil, peanut oil, safflower oil, coconut oil, rapeseed oil, cotton seed oil, mixtures thereof and wherein said organic residue particulate passes through a 17 mesh screen.

18. The method of claim 17 wherein said herbicide is diquat dibromide.

19. A method of treating a substantially non-dynamic water reservoir having at least one invasive aquatic plant flora comprising the steps of:
a) preparing the herbicide mixture of claim 15; and
b) contacting at least a portion of the invasive aquatic plant flora with said herbicide mixture.

20. The method of claim 19 wherein said invasive aquatic plant flora is selected from the group consisting of duckweed, watermeal and parrotfeather, and wherein said herbicide is diquat dibromide.
